(19) United States
(12) Patent Application Publication
(10) Pub. No.: US 2009/0026847 A1
(43) Pub. Date: Jan. 29, 2009

(54) LINEAR MOTOR

(76) Inventors: Houng Joong Kim, Mito (JP); Hitoshi Shibata, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/280,014

(22) PCT Filed: Mar. 31, 2006
(86) PCT No.: PCT/JP2006/307395

§ 371 Date: Aug. 20, 2008

(51) Int. Cl. H02K 41/03

(52) U.S. Cl. 310/12

(57) ABSTRACT

In prior art linear motor, large burden is applied to a mechanism for supporting a moving member because magnetic attracting force acts in one direction between armature and moving member and the structure is distorted to cause various troubles. In inventive linear motor, a stator having armature winding and moving member having permanent magnets are arranged to move relatively. The linear motor stator includes a ring-shaped core, armature teeth and armature winding to form a magnetic circuit. Slit grooves are formed in armature teeth opposed to both of front and rear surfaces of the permanent magnets of the moving member with an air gap defined between stator and moving member. Projected members movable along the slit grooves of the armature teeth are provided on the permanent magnet surfaces. Thus magnetic attracting force can be canceled and the member having the permanent magnets can have a high rigidity.

### TECHNICAL FIELD

The present invention relates to linear motors and more particularly to a linear motor which includes a primary side member having a ring-shaped core, armature teeth and an armature winding which form a magnetic circuit, and also includes a secondary side member of a permanent magnet which is reciprocatably driven through an air gap in part of the ring-shaped core.

### BACKGROUND ART

Major ones of prior art linear motors have a structure that rotary machine is cut and linearly developed and includes a stator having an armature winding and a moving member movably supported with an air gap spaced from the stator. Thus, a large magnetic attracting force takes place between the stator and the moving member, a large burden is applied to a support mechanism for keeping the air gap constant, and the overall size of the machine becomes large.

In the prior art, further, a plurality of coils are wound around a single stator unit and different coils are wound around adjacent stator magnetic poles, thus resulting in that the entire structure of the machine becomes complicated.

In order to solve the above defects in the prior art, an object of the present invention is to provide a linear motor which can cancel a magnetic attracting force acting between a primary side member (stator) and a secondary side member (moving member) with a compact structure and which can increase the rigidity of the secondary side member having permanent magnets while keeping the characteristics of a magnetic circuit by devising a method of arranging an armature winding.

A patent document relating to the prior art linear motor is International Patent Publication WO00/69051.

### DISCLOSURE OF THE INVENTION

In accordance with the present invention, the above objects are attained by providing a linear motor which includes a plurality of permanent magnets arranged along an advancing direction and a core opposed to both of front and rear surfaces of the permanent magnets to form a closed magnetic circuit. In the linear motor, a slit groove is formed in each of armature teeth of the core, a projected (protruded) member movable along the slit groove is provided. A plurality of members each having at least one permanent magnet are combined and the projected member is arranged so that adjacent magnetic polarities along the advancing direction are different from each other.

In accordance with the present invention, the above objects are also attained by providing a linear motor which includes a plurality of permanent magnets arranged along a proceeding direction and a core opposed to both of front and rear surfaces of the magnetic materials to form a closed magnetic circuit. In the linear motor, a slit groove is formed in each of armature teeth of the core, a projected (protruded) member movable along the slit groove is provided, and members having at least the one permanent magnet are combined with the projected member.

In accordance with the present invention, the above object are attained by providing a linear motor which includes a plurality of permanent magnets arranged along a proceeding direction and a core opposed to both of front and rear surfaces of the permanent magnets to form a closed magnetic circuit. In the linear motor, a slit groove is formed in each of armature teeth of the core, a projected (protruded) member movable along the slit groove is provided, and the projected member is provided on each of both surfaces of the members having at least the one permanent magnet in combination with another member.

### BRIEF DESCRIPTION OF THE DRAWINGS

FIG. 1 shows a basic arrangement of a linear motor in accordance with an embodiment of the present invention;

FIG. 2 shows a ring-shaped core in a linear motor in accordance with another embodiment of the present invention;

FIG. 3 shows a moving member in a linear motor of another embodiment of the present invention;

FIG. 4 shows a moving member in a linear motor in accordance with an embodiment of the present invention;

FIG. 5 shows an exploded diagram of a moving member in a linear motor in accordance with an embodiment of the present invention;

FIG. 6 is a diagram for explaining how to assemble a moving member in a linear motor in accordance with an embodiment of the invention;

FIG. 7 shows a first diagram for explaining how to assemble a moving member in a linear motor in accordance with another embodiment of the invention;

FIG. 8 shows a second diagram for explaining how to assemble a moving member in a linear motor in accordance with another embodiment of the invention;

FIG. 9 shows a third diagram for explaining how to assemble a moving member in a linear motor in accordance with another embodiment of the invention;

FIG. 10 shows a fourth diagram for explaining how to assemble a moving member in s linear motor in accordance with another embodiment of the invention;

FIG. 11 shows an exploded diagram of a moving member in a linear motor in accordance with another embodiment of the invention;

FIG. 12 shows examples of a permanent magnet unit in a linear motor in accordance with the present invention;

FIG. 13 shows a fifth diagram for explaining how to assemble a moving member in a linear motor in accordance with another embodiment of the present invention;

FIG. 14 is a diagram for explaining an arrangement of coils in a linear motor in accordance with another embodiment of the present invention;

FIG. 15 shows a core and a moving member in a linear motor in accordance with another embodiment of the present invention;

FIG. 16 shows different moving members in a linear motor in accordance with another embodiment of the present invention; and

FIG. 17 shows an arrangement of a servo control system which is applied to the linear motor of the present invention.

### BEST MODE FOR CARRYING OUT THE INVENTION

Explanation will be made as to embodiments of the present invention with reference to the attached drawings. In the drawings, constituent elements having the same or equivalent functions are denoted by the same reference numerals or symbols.

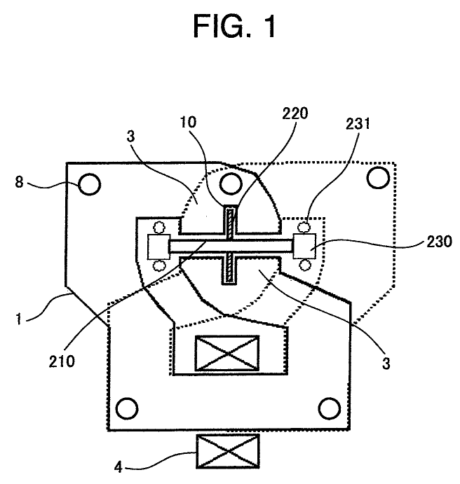

FIG. 1 shows a basic arrangement of a moving member in a linear motor in accordance with an embodiment of the present invention.

In FIG. 1, the linear motor includes a stator as a primary side member having an armature winding 4 and a moving member 210 as a secondary side member having permanent magnets, the moving member 210 being relatively movable with respect to the stator. A basic system arrangement is the same as the contents disclosed in International Patent Publication WO00/69051, unless otherwise noted.

The stator of the linear motor includes a ring-shaped core 1, armature teeth 3, and an armature winding 4 which form a magnetic circuit. In the linear motor, a slit groove 10 is formed in each of the armature teeth 3 of the ring-shaped core opposed to both of front and rear surfaces of the permanent magnets of the moving member with an air gap, and projected members 220 movable along the slit grooves 10 of the armature teeth 3 are provided on the both surfaces of the permanent magnets.

The armature teeth 3 are formed in parts of the ring-shaped core opposed to the both front and rear surface of the permanent magnets of the moving member 210 with the air gap defined therebetween, guide rails 230 are provided along the longitudinal direction of the moving member, and support mechanisms 231 are located to the ring-shaped core 1 in combination with the guide rails 230. In order to assemble a plurality of such ring-shaped cores 1, through holes 8 are formed in parts of the ring-shaped cores.

The support mechanisms 231 are located at both sides of the moving member 210, but the shape of the support mechanism may be mixedly combined with the guide rails (not shown) of the moving member. As the supporting method, a noncontact supporting method based on aero static bearing, hydrostatic bearing or the like and a supporting method based on plane sliding, linear guide rail or the like may be employed.

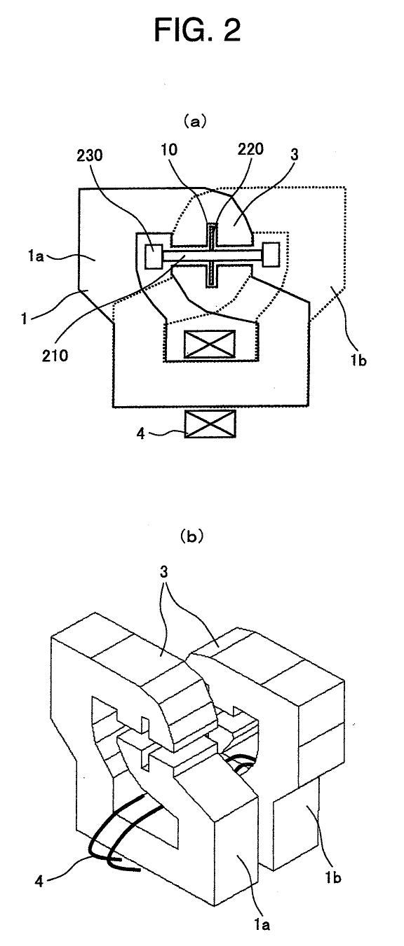

FIG. 2 shows a conceptional diagram of a ring-shaped core in a linear motor in accordance with an embodiment of the present invention.

FIG. 2 schematically shows the arrangement of the common armature winding 4 to an odd-numbered ring-shaped core 1a and an even-numbered ring-shaped core 1b. In FIG. 2(b), only two of the ring-shaped cores are illustrated. However, even when two or more of the odd-numbered ring-shaped cores and two or more of the even-numbered ring-shaped cores are provided, they may be arranged with use of the single armature winding 4.

With such an arrangement, magnetic fields in opposed directions can be established between the magnetic poles of the adjacent cores by causing a current to flow through the single armature winding.

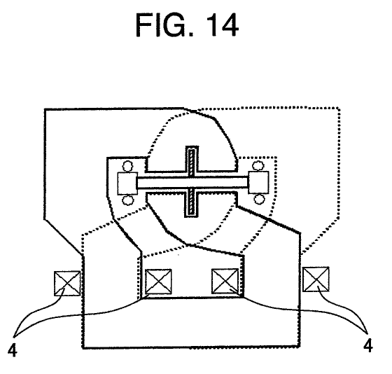

FIG. 14 shows a conceptional diagram of a plurality of coils arranged in a linear motor in accordance with an embodiment of the present invention.

FIG. 14 shows an example when the armature windings 4 are separately located at the right and left parts of the ring-shaped core. It is necessarily required to commonly wind the armature winding 4 around the entire ring-shaped cores, and the armature winding may be wound at any location so long as the armature winding will not hinder the movement of the moving member 210. Although two armature windings are illustrated, one of the windings may be selected and combined.

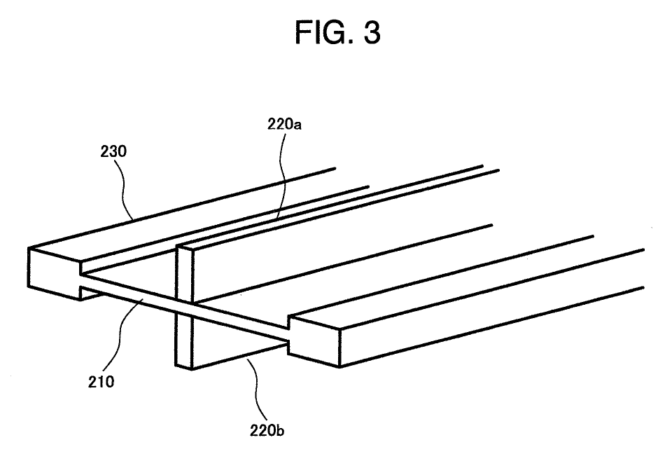

FIG. 3 shows a moving member in a linear motor in accordance with an embodiment of the present invention.

In FIG. 3, projected (protruded) members 220a and 220b are provided on the front and rear surfaces of the moving member 210 at its middle part, and the guide rails 230 are provided at both sides of the moving member 210 along its longitudinal direction.

In this way, the projected members 220a and 220b are provided on the front and rear surfaces of the moving member 210 of the secondary side member at its middle part, so that, even when the moving member of the secondary side member is formed to be elongated along the longitudinal direction of the linear motor, the moving member can have a high rigidity. As a result, even when the moving member is driven at a high speed, the moving member can be less distorted.

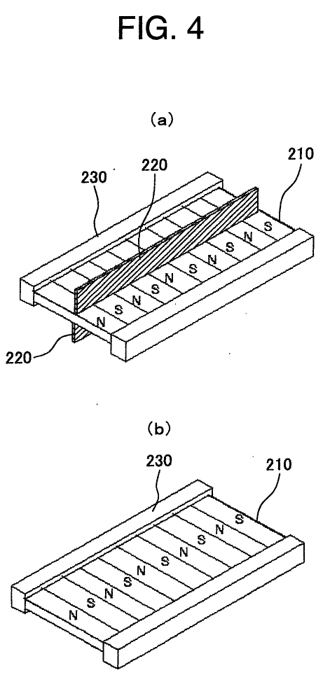

FIG. 4 shows the moving member in the linear motor in accordance with the embodiment of the present invention and a moving member in a prior art linear motor for comparison therebetween.

FIG. 4(a) show the moving member in the linear motor of the present invention having the projected members 220 provided on the front and rear surfaces of the moving member 210 at its middle part, and FIG. 4(b) shows the moving member in the prior art linear motor not provided at its middle part on the front and rear surfaces of the moving member 210. In the linear motor according to the invention, since the projected members 220 are provided on the front and rear surfaces of the moving member 210 at its middle part, the moving member can have a large sectional moment of the second order (moment of inertia of area) and can advantageously have a strong rigidity.

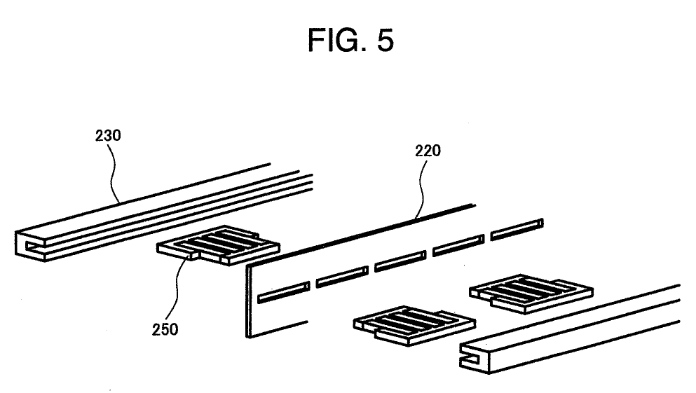

FIG. 5 shows an exploded diagram of a moving member in a linear motor in accordance with the present invention.

A permanent magnet case 250 has such a shape as to receive a plurality of permanent magnets as a unit. Holes are formed in the projected member 220 at its middle part at intervals of a predetermined distance in order to receive the permanent magnet cases 250 therein, and the guide rail 230 and the projected members 220 sandwiches the permanent magnet cases therebetween. In the embodiment shown in FIG. 5, two of the projected members 220a and 220b of the moving member 210 of FIG. 3 can be advantageously formed as the single projected member 220.

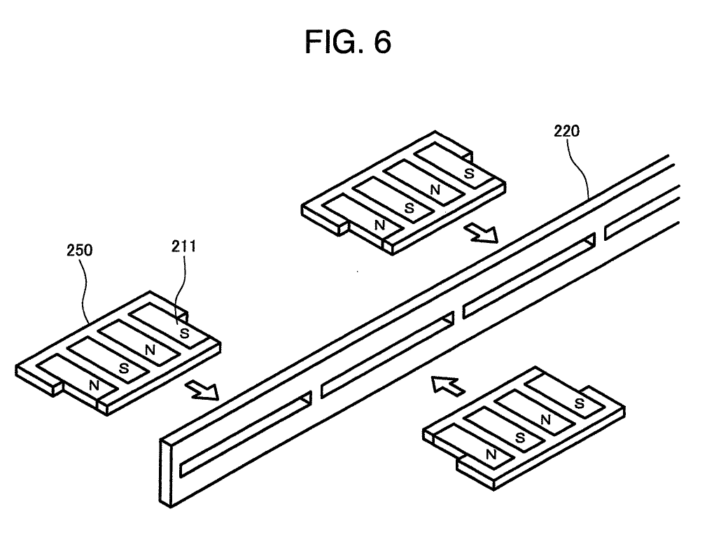

FIG. 6 shows an example of how to assemble a moving member as a secondary side member in the linear motor of the present invention.

In FIG. 6, the permanent magnets 211 are accommodated in the permanent magnet case 250 so as to have pole polarities of N, S, N and S in this order and to be spaced at intervals of a predetermined distance, and such permanent magnet cases 250 are inserted into holes which are formed in the middle part of the projected member and are spaced at intervals of a predetermined distance, from both sides of the projected member 220.

With such a structure, when the common permanent magnet cases 250 are formed and the permanent magnets 211 are inserted in each permanent magnet case, and then such cases are inserted in the projected members 220; a moving member as the primary side member can be assembled.

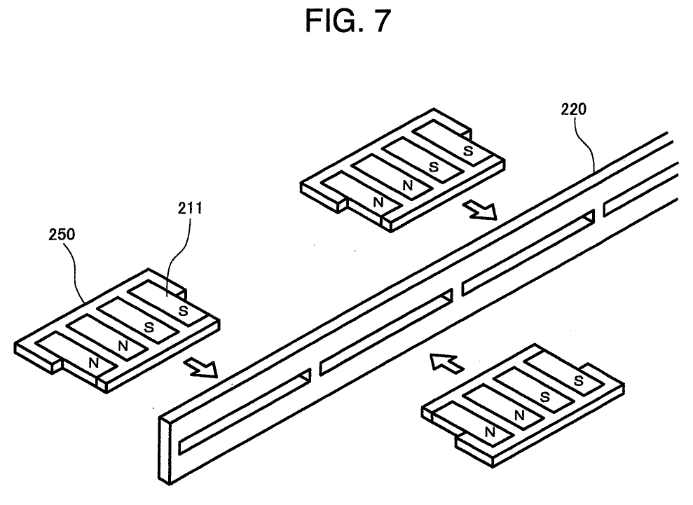

FIG. 7 shows another example of how to assemble the moving member in the linear motor of the present invention.

FIG. 7 is the same as FIG. 6 in that the shape of the permanent magnet case 250 and the shape of the projected member 220 are the same as those of the corresponding case and projected member, but different therefrom in that a plurality of such permanent magnets 211 are arranged to have the same magnetic polarity, that is, arranged so that the permanent magnets 211 have pole polarities of N, N, S, and S in this order.

This is effective when a linear motor having varied pole pitches is manufactured with use of permanent magnets and projected members having the same shape.

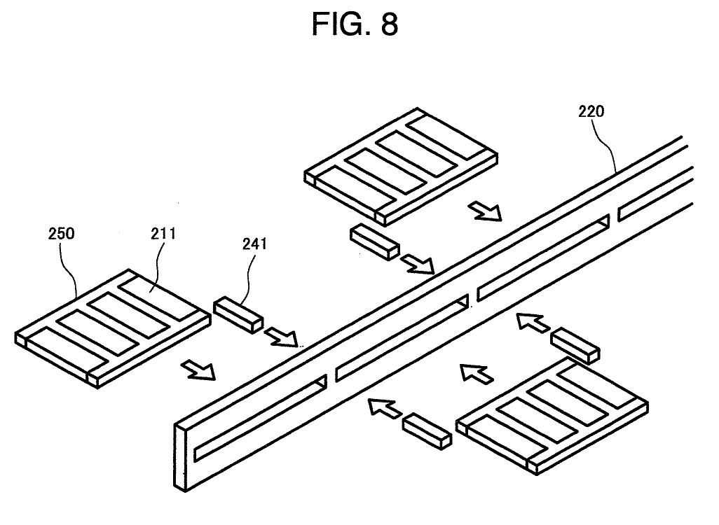

FIG. 8 shows another example of how to assemble a moving member in a linear motor of the present invention.

In FIG. 8, when compared with the foregoing embodiment, the permanent magnet case 250 is more simply manufactured, and parts of the permanent magnet case at its both sides are instead used as spacers 241.

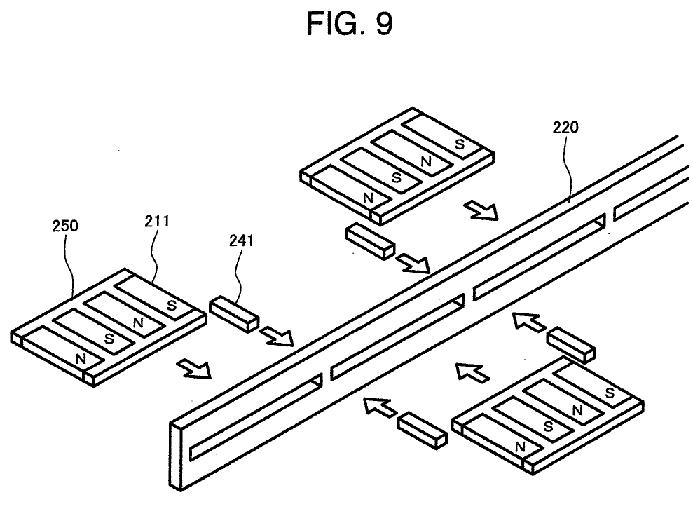

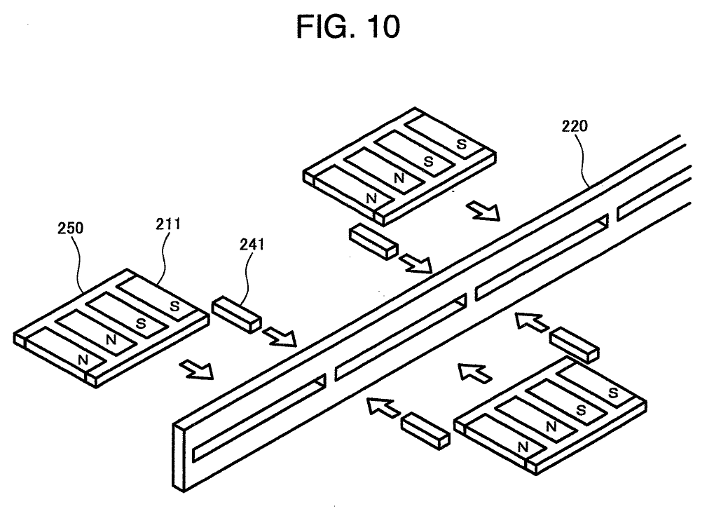

FIGS. 9 and 10 show other examples of how to assemble a moving member in a linear motor of the present invention.

In FIG. 9, the permanent magnets 211 are accommodated in the permanent magnet case 250 so as to have pole polarities of N, S, N, and S in this order and to be spaced at intervals of a predetermined distance.

FIG. 10 has the same structure as that of FIG. 9 in the shape of the permanent magnet case 250 and in the shape of the projected member 220, but different from FIG. 9 in that a plurality of permanent magnets 211 are arranged to have the same pole polarity. FIG. 10 shows an example when the permanent magnets 211 are arranged to have pole polarities of N, N, S, and S in this order.

With such an arrangement, when permanent magnet cases having the same shape are used and combined with the projected members 220, a moving member as the secondary side member can be easily assembled.

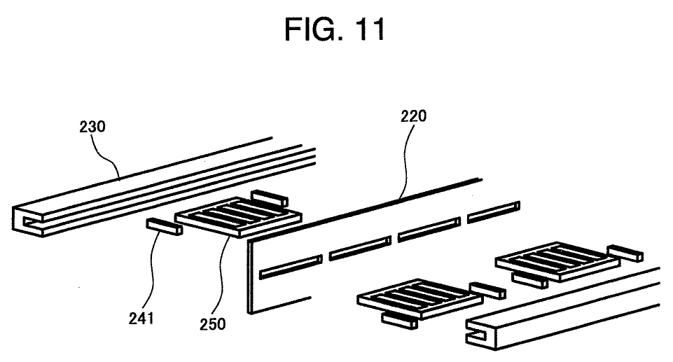

FIG. 11 shows another example of an exploded diagram of a moving member as a secondary side member in a linear motor of the present invention.

In FIG. 11, the permanent magnet case 250 is inserted in each hole of the projected member 220 at its middle part of the hole, spacers 241 are inserted in the hole at its both sides, and then the permanent magnet case and the spacers 241 are pushed by the guide rail 230. The respective constituent elements may also be fixed by means of use of an adhesive, welding, bolt, pin, rivet or the like.

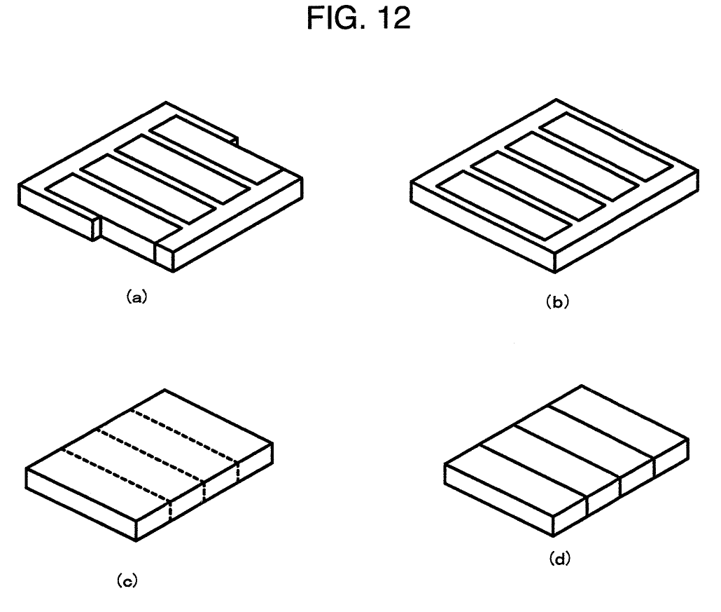

FIG. 12 shows examples of the permanent magnet unit for a linear motor of the present invention.

In FIG. 12, FIGS. 12(a) and 12(b) show the permanent magnet cases having permanent magnets accommodated therein. When the common permanent magnet cases are manufactured and permanent magnets are accommodated therein, even a moving member as an elongated primary side member can be manufactured. FIG. 12(c) shows an example when a single permanent magnet block is magnetized to have a plurality of pole polarities. When this permanent magnet block is employed, a moving member as a secondary side member having a strong strength can be manufactured. FIG. 12(d) shows an example when a plurality of separated permanent magnets alone are combined into a unit. A moving member as a secondary side member can be manufactured with a less number of members.

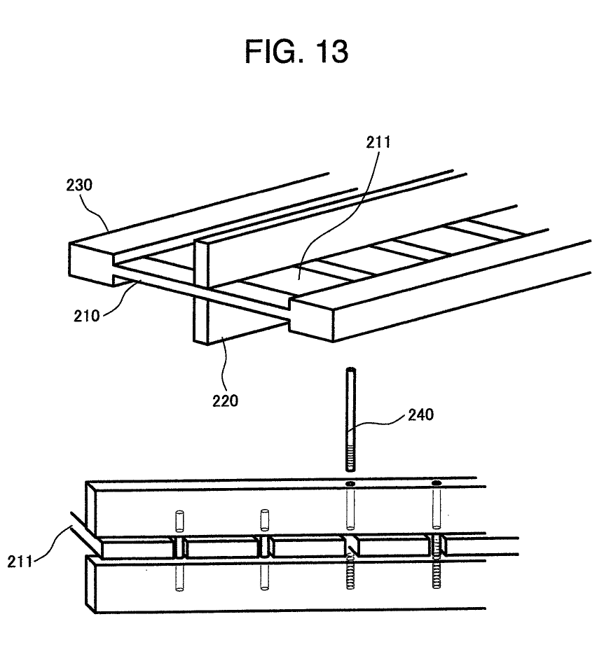

FIG. 13 shows another example when a moving member in a linear motor of the present invention is assembled.

In the example of FIG. 13, projected members sandwiching the permanent magnets 211 are assembled by means of bolts 240 as an example. Of course, the bolts 240 may be replaced with pin, rivet adhesive material, welding or the like.

When the permanent magnets 211 in the linear motor of the present invention are skewed, it is possible to change a predetermined distance between the N and S poles, or it is also possible the permanent magnets to have a shape other than a rectangle.

There may be provided a linear motor which uses ferroelectric materials in place of the permanent magnets 211 forming the moving member 210 shown in the linear motor of the present invention, or may be provided a linear motor which has a structure of a combination of the permanent magnets and the ferroelectric materials. Further, there may be provided a linear motor which uses electromagnets having air core coils wound therearound or uses electromagnets having ferroelectric materials and coils wound therearound in place of the permanent magnets, and arranged to have pole polarities of N, S, N and S in this order.

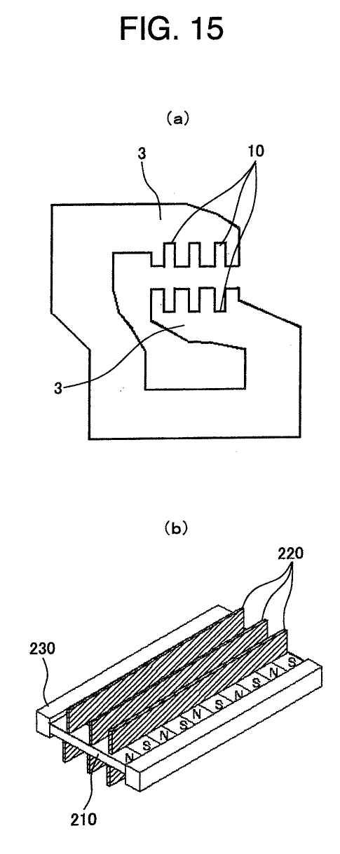

FIG. 15 shows a core and a moving member in a linear motor in accordance with another embodiment.

FIG. 15(a) shows an example when a plurality of slit grooves 10 are formed in the surfaces of armature teeth 3 of a ring-shaped core opposed to both of front and rear surfaces of permanent magnets of the moving member 210 with an air gap defined therebetween (3 slit grooves in the upper surfaces and 3 slit grooves in the lower surface, that is, a total of 6 slit grooves in FIG. 15). FIG. 15(b) shows an example when a plurality of the projected members 220 corresponding in shape to the armature teeth are provided on both of the front and rear surfaces of the moving member 210. With such an arrangement, the rigidity of the moving member as the secondary side member can be increased.

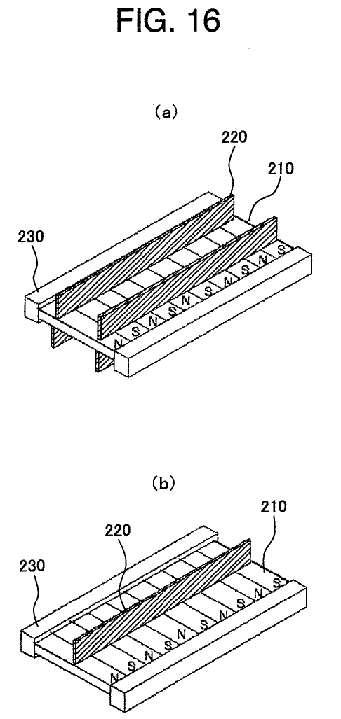

FIG. 16 shows moving members of linear motors in accordance with other embodiments of the present invention.

FIG. 16(a) shows a structure of the linear motor when a plurality of (two in this case) projected members are provided on both of the front and rear surfaces of the moving member 210 at locations slightly offset from the midpoint of the moving member. Even with this arrangement, the rigidity of the moving member can be increased.

FIG. 16(b) shows a structure of the linear motor a single projected member is provided only on one of the both front and rear surfaces of the moving member 210 along its longitudinal direction. Even with this arrangement, the rigidity of the moving member can be increased.

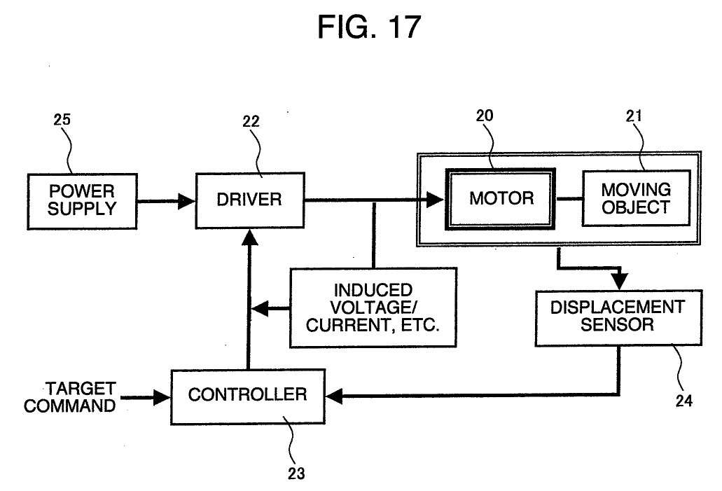

FIG. 17 shows an arrangement of a servo control system using the linear motor of the present invention.

In this system, a linear motor 20 of the present invention is coupled to a moving object 21. The system also includes a driver 22, a controller 23 and a displacement sensor 24. The system is driven according to a target command. Although the system is illustrated as a closed loop control type using the displacement sensor 24 in FIG. 12, an open loop control type without using the displacement sensor may be employed for the system depending on its application. The system also can employ an accurate, high-performance servo control type using a current sensor, magnetic polarity detecting sensor or the like (not shown).

In FIG. 17, with respect to the displacement sensor 24, as in the prior art linear motor, an encoder scale (not shown) is provided along the longitudinal direction of the moving member 210 and an encoder detector (not shown) is provided at a location opposed to the encoder scale, so as to be used as a linear driving device.

Explanation has been made in connection with the aforementioned linear motor of the present invention when the armature winding is provided to the ring-shaped core or to the armature teeth as an example. However, a mixed combination among the core, the armature tooth and the armature winding may be possible.

The foregoing embodiments of the linear motor of the present invention have been explained in connection with the case where the permanent magnets are provided to the moving member and the armature winding is provided to the stator. However, to the contrary to this case, the armature winding may be provided to the moving member and the permanent magnets may be provided to the stator.

Further, in addition to the embodiments of the aforementioned combinations, a combination of only parts of the constituent elements may be employed. The respective constituent elements of the linear motors shown in the drawings may be combined among the linear motors independently of the respective embodiments of the drawings and the combination may be molded.

### INDUSTRIAL APPLICABILITY

As has been explained in the foregoing, in accordance with the present invention, there is provided such a linear motor that a magnetic attracting force acting between the stator and the moving member can be canceled with a compact structure. Further, a high-rigidity linear motor having a member of permanent magnets can be provided.

1. A linear motor comprising:
a plurality of permanent magnets arranged along a proceeding direction; and
a core opposed to both of front and rear surfaces of the permanent magnets to form a closed magnetic circuit, wherein
a slit groove is formed in each of armature teeth of the core, a projected member movable along the slit groove is provided, a plurality of members each having at least one permanent magnet are combined and arranged to projected members so that adjacent ones of the permanent magnets have different pole polarities.

2. The linear motor according to claim 1, wherein the members having at least one permanent magnet have the same shape.

3. The linear motor according to claim 1, wherein the members having at least one permanent magnet are combined with the projected member.

4. The linear motor according to claim 3, wherein the members having at least one permanent magnet are inserted in holes provided in the projected member to be combined therewith.

5. The linear motor according to claim 1, wherein the stator is fixedly supported and the moving member is moved.

6. The linear motor according to claim 1, wherein the moving member is fixedly supported and the stator is moved.

7. A linear motor comprising:
a plurality of permanent magnets arranged along a proceeding direction; and
a core opposed to both of front and rear surfaces of the permanent magnets to form a closed magnetic circuit, wherein
a slit groove is formed in each of armature teeth of the core, a projected member movable along the slit groove is provided, and members having at least one permanent magnet are combined with the projected member.

8. The linear motor according to claim 7, wherein the members having at least one permanent magnet are inserted in holes provided in the projected member and combined therewith.

9. The linear motor according to claim 7, wherein the members having at least one permanent magnet have the same shape.

10. A linear motor comprising:
a plurality of permanent magnets arranged along an advancing direction; and
a core opposed to both of front and rear surfaces of the permanent magnets to form a closed magnetic circuit, wherein
a slit groove is formed in each of armature teeth of the core, a projected member movable along the slit groove is provided, and the projected members are provided at both surfaces of members each having at least one permanent magnet to be combined therewith.

11. The linear motor according to claim 10, wherein the projected members are provided at both surfaces of the member having the permanent magnets to be combined with other members with use of an adhesive member.
